(19) United States
(12) Patent Application Publication
(10) Pub. No.: US 2025/0369787 A1
(43) Pub. Date: Dec. 4, 2025

(54) MULTIMODE MULTIPHASE CORIOLIS METER

(71) Applicant: Saudi Arabian Oil Company, Dhahran (SA)

(72) Inventors: Sakethraman Mahalingam, Aberdeen (GB); Manus Henry, Oxford (GB); Michael Tombs, Oxford (GB); Feibiao Zhou, Oxford (GB); Muhammad Arsalan, Dhahran (SA)

(73) Assignees: Saudi Arabian Oil Company, Dhahran (SA); Aramco Overseas Company B.V., The Hague (NL)

(21) Appl. No.: 18/679,970

(22) Filed: May 31, 2024

(51) Int. Cl. G01F 1/84

(52) U.S. Cl. CPC G01F 1/8486; G01F 1/8413; G01F 1/8436

(57) ABSTRACT

A multimode Coriolis flow meter, methods, and systems may include a vibratable conduit configured to channel a flow of a multiphase fluid, a plurality of drivers connected to the vibratable conduit configured to induce a plurality of vibration modes to the vibratable conduit, and a plurality of sensors connected to the vibratable conduit and configured to generate a plurality of sensor signals of the vibratable conduit in response to the plurality of vibration modes. The multimode Coriolis flow meter may further include a Coriolis transmitter.

### BACKGROUND

Coriolis flow meters measure mass flow rate and density of a fluid by means of the Coriolis effect. A drive system, typically consisting of a magnet and a coil, oscillates a flowtube at the natural frequency of a selected mode of mechanical vibration. Two sensors register a voltage signal proportional to their relative displacement. A phase difference between these signals is used to determine the mass flow rate through the flowtube. A Coriolis flow meter also provides a direct density measurement, which is proportional to the vibrating frequency of the flowtube. As the fluid becomes denser, the vibrational frequency of the flowtube decreases. A Coriolis transmitter monitors and maintains the flowtube oscillation and derives the mass flow rate and density properties of a fluid from the sensor signals.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a multimode Coriolis flow meter including a vibratable conduit configured to channel a flow of a multiphase fluid, a plurality of drivers connected to the vibratable conduit configured to induce a plurality of vibration modes to the vibratable conduit, and a plurality of sensors connected to the vibratable conduit and configured to generate a plurality of sensor signals of the vibratable conduit in response to the plurality of vibration modes. The multimode Coriolis flow meter further includes a Coriolis transmitter configured to transmit a plurality of drive signals to the plurality of drivers to maintain a continuous motion of the vibratable conduit in the plurality of vibration modes, and to receive the plurality of sensor signals from the plurality of sensors. The Coriolis transmitter is further configured to determine, via a Prism signal processing, a plurality of frequencies, a plurality of amplitudes, and a plurality of phase differences for each of the plurality of vibration modes based on the sensor signals. The Coriolis transmitter is further configured to generate an apparent mixture mass flow rate measurement for each of the plurality of vibration modes corresponding to the continuous motion of the vibratable conduit based, at least in part, on the plurality of phase differences. The Coriolis transmitter is further configured to generate an apparent mixture density measurement for each of the plurality of vibration modes corresponding to the continuous motion of the vibratable conduit based, at least in part, on the plurality of frequencies.

Embodiments disclosed herein generally relate to a non-transitory computer readable medium storing instructions executable by a computer processor. The instructions include functionality for obtaining data from a plurality of sources, the data including temperature, pressure, apparent mixture mass flow rate for each of a plurality of vibration modes, and apparent mixture density for each of a plurality of vibration modes. The instructions further include functionality for processing the obtained data, where the processing includes cleaning and normalizing the obtained data. The instructions further include functionality for determining, using a correction model, a mixture mass flow rate error and a mixture density error based on, at least, the processed data. The instructions further include functionality for determining, using the correction model, a corrected mixture mass flow rate and a corrected mixture density based on, at least, the mixture mass flow rate error and the mixture density error. The instructions further include functionality for determining, using the correction model, corrected mass flow rates of individual multiphase flow components in real-time based on, at least, the corrected mixture mass flow rate and the corrected mixture density.

Embodiments disclosed herein generally relate to a system. The system includes a vibratable conduit configured to channel a flow of a multiphase fluid. The system further includes a plurality of drivers connected to the vibratable conduit configured to induce a plurality of vibration modes to the vibratable conduit and a plurality of sensors connected to the vibratable conduit and configured to generate a plurality of sensor signals of the vibratable conduit in response to the plurality of vibration modes. The system further includes a Coriolis transmitter. The system further includes a multiphase flow error correction system including a computer processor, where the multiphase flow error correction system is coupled to the Coriolis transmitter. The multiphase flow error correction system includes functionality for obtaining data from a plurality of sources, the data including temperature, pressure, apparent mixture mass flow rate for each of the plurality of vibration modes, and apparent mixture density for each of the plurality of vibration modes. The multiphase flow error correction system further includes functionality for processing the obtained data, where the processing includes cleaning and normalizing the obtained data. The multiphase flow error correction system further includes functionality for determining, using a correction model, a mixture mass flow rate error and a mixture density error based on, at least, the processed data. The multiphase flow error correction system further includes functionality for determining, using the correction model, a corrected mixture mass flow rate and a corrected mixture density based on, at least, the mixture mass flow rate error and the mixture density error. The multiphase flow error correction system further includes functionality for determining, using the correction model, corrected mass flow rates of individual multiphase flow components in real-time based on, at least, the corrected mixture mass flow rate and the corrected mixture density.

Other aspects and advantages of the claimed subject matter will be apparent from the following description and the appended claims.

### BRIEF DESCRIPTION OF DRAWINGS

FIG. 1 depicts a multimode Coriolis flow meter, in accordance with one or more embodiments.

FIG. 2 depicts a multiphase fluid flowing in a flowtube, in accordance with one or more embodiments.

FIG. 3 depicts a multimode Coriolis flow meter, in accordance with one or more embodiments.

FIG. 4 depicts a system, in accordance with one or more embodiments.

FIG. 5 depicts a flowchart, in accordance with one or more embodiments.

FIG. 6 depicts a system, in accordance with one or more embodiments.

FIG. 7 depicts a neural network, in accordance with one or more embodiments.

FIG. 8A depicts a visualization of a mixture mass flow rate error for two vibration modes, in accordance with one or more embodiments.

FIG. 8B depicts a visualization of a mixture density error for two vibration modes, in accordance with one or more embodiments.

FIG. 9A depicts a prototype Coriolis transmitter, in accordance with one or more embodiments.

FIG. 9B depicts a prototype Coriolis transmitter circuitry, in accordance with one or more embodiments.

FIG. 10 depicts a flowchart, in accordance with one or more embodiments.

FIG. 11 depicts a computing system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “driver” may include any number of “drivers” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

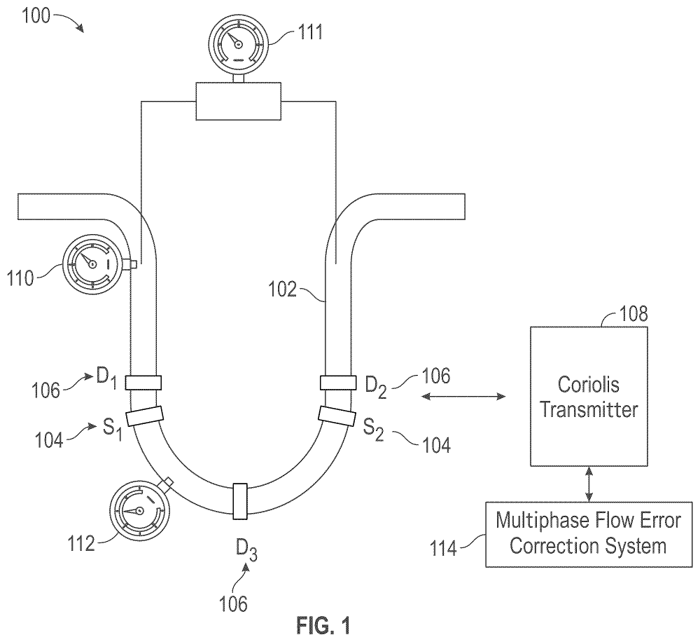

In the following description of FIGS. 1-11, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Coriolis mass flow metering is a widely used technique for industrial flow measurements. Typically, a Coriolis flow meter measures mass flow rate and density of a single-phase flow by driving a flowtube (also referred to as a vibratable conduit) at the natural resonant frequency of a single mode of mechanical vibration. Coriolis flow meters operate based on the Coriolis effect, which is directly related to mvΩ, where m is the mass of material in a cross section of a loop, v is the velocity at which the mass is moving, and Ω is the angular velocity of the loop. Mass flow rate is related to the motion induced in the flowtube in response to a driving force supplied by the one or more drivers. Specifically, the phase shift between two sensor signals is used to determine the mass flow rate of the fluid flowing through the flowtube. The Coriolis flow meter may also provide a measurement of the density, which is related to the frequency of motion of the flowtube.

Conventional Coriolis flow meters are unable to perform well when presented with a multiphase flow. There are two aspects to this problem. In one aspect, it may be difficult to maintain flowtube oscillation, due to a dramatic rise in flowtube damping. For example, the earliest Coriolis meters using analog electronics were unable to maintain flowtube oscillation in the highly damped conditions generated by a two-phase flow, even for the slightest amounts of gas void fraction (GVF) (defined as the percentage of gas by volume: GVF=α=volume of gas/total volume). Mechanical energy is lost in the interactions between compressible bubbles, fluid, and flowtube walls, and the drive energy required to maintain oscillation rises sharply. Not only does the damping rise, but it varies rapidly due to the chaotic nature of the interactions, which may cause the Coriolis flow meter to stall or output inaccurate measurements. Tens of seconds may elapse before nominal performance is restored. In recent years, using digital drives, it has been possible to maintain operation through most gas/liquid mixtures of a two-phase flow. However, maintaining oscillation is only the first step in obtaining a satisfactory measurement performance. The reason is that multiphase flows induce potentially large, variable, but repeatable errors in the apparent (i.e., as determined by the multimode Coriolis flow meter) mixture mass flow rate and apparent mixture density measurements.

Embodiments of the present invention extend beyond prior art multiphase Coriolis flow metering by driving the flowtube to operate in one or more different vibration modes simultaneously. The prior art teaches that the mass flow and density readings from a Coriolis flow meter (operating in a single vibration mode) have potentially large but systematic errors which are a function of factors including the fluid properties, the flow rates, and the flowtube geometry. If the error characteristics are learned and a correction model developed, for example using a machine learning model, then for two-phase (e.g., gas/liquid) flows it is possible to determine two unknowns (e.g., liquid and gas flow rates) from configured fluid property information (e.g., pure fluid densities) and the two readings (apparent mixture mass flow rate and apparent mixture density) from the flow meter. However, for three-phase flows (e.g., oil/water/gas) or two-phase flows where the fluid properties may vary (e.g., varying gas composition, liquid density), there are at least three unknowns, and the mass flow and density readings obtained from a single vibration mode are insufficient to resolve the individual multiphase flow components. In the prior art, additional instrumentation (e.g., a water cut meter, an oil cut meter, etc.) is used alongside the Coriolis flow meter to provide the additional readings required to determine the desired flow characteristics. The present invention may eliminate the need for a water cut meter or may improve the accuracy of a multiphase Coriolis meter where readings from a water cut meter are provided.

Embodiments disclosed herein generally relate to a multimode Coriolis flow meter capable of maintaining oscillation of the flowtube in one or more vibration modes simultaneously and generating an apparent mixture mass flow rate and an apparent mixture density measurement for each vibration mode. The key benefit is that the mass flow and density error characteristics may be, in general, different for the one or more vibration modes. Thus, in multiphase flow conditions the multimode Coriolis flow meter operating in two modes of vibration generates four distinct readings, which may enable the calculation of three or more parameters (e.g., individual mass flow rates for each component of a three-phase flow) without the need for additional instrumentation (e.g., a water cut meter). Alternatively, these readings may be used in combination with those from additional instrumentation to provide improved corrections. As such, the multimode Coriolis flow meter presented in this invention may maintain flowtube operation when presented with a multiphase flow and may correct apparent mixture mass flow rate and apparent mixture density errors over a wide range of multiphase flow conditions.

Embodiments disclosed herein generally relate to a multiphase flow error correction system. As will be described, this system uses a correction model to determine a mixture mass flow rate error and a mixture density error of a multiphase flow. A corrected mixture mass flow rate and a corrected mixture density may be obtained based on, at least, the mixture mass flow rate error and a mixture density error as determined using the correction model. In one or more embodiments, the correction model is used to provide corrected mass flow rates of the individual multiphase flow components in real-time or near real-time. In some embodiments, the correction model may be a machine learning model. In other embodiments, the correction model may be a multivariable polynomial model. Further, in another embodiment of the present invention, independent measurements from each vibration mode may be used for cross-validation and diagnostics of the multimode Coriolis flow meter operation. In one or more embodiments, independent measurements from each vibration mode may be used to identify features present in the spectral analysis of the sensor signals. One with ordinary skill in the art will appreciate that many more examples exist, as will be described later in the instant disclosure, and may be used without limiting the scope of the present disclosure.

Machine learning, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), will be adopted herein, however, one skilled in the art will recognize that the concepts and methods detailed hereafter are not limited by this choice of nomenclature.

FIG. 1 shows a multimode Coriolis flow meter (100) in accordance with one or more embodiments. The multimode Coriolis flow meter (100) may include a flowtube (102), one or more sensors (104), one or more drivers (106), a Coriolis transmitter (108), a pressure sensor (110), a differential pressure sensor (111), a temperature sensor (112), and a multiphase flow error correction system (114). The multimode Coriolis flow meter (100) may be used to measure one or more physical characteristics of a multiphase fluid traveling through the flowtube (102). Examples of physical characteristics may include, but are not limited to, apparent mixture mass flow rate and apparent mixture density of the multiphase fluid.

Generally, the flowtube (102) consists of two parallel tubes conveying the multiphase fluid, arranged either in series or in parallel, where the sensors (104) and drivers (106) are placed between the tubes to generate and monitor their relative motion. In FIG. 1, the flowtube (102) is depicted as a single tube. However, one with ordinary skill in the art will appreciate that many alternative flowtube (102) geometries exist and may be used without limiting the scope of the present disclosure. For example, the flowtube (102) design may include a single tube, a plurality of tubes, a straight tube design, or complex bending designs, connected in series or in parallel.

In accordance with one or more embodiments, the multimode Coriolis flow meter (100) may include sensors for sensing characteristics of substances passing through or otherwise located in the flowtube (102). The sensor readings may include, at least, data about pressure and temperature. The sensor readings may be obtained using specialized tools such as, for example, temperature sensors (e.g., resistance temperature detectors, thermocouples, etc.) and pressure gauges (e.g., bourdon tube pressure gauges, diaphragm pressure gauges, etc.) disposed at one or more locations along the flowtube (102). In some implementations, pressure may be measured with a pressure sensor (110) and a differential pressure sensor (111), while the temperature may be independently measured using a temperature sensor (112) disposed along the flowtube (102).

As previously noted, a Coriolis flow meter is conventionally operated in a single vibration mode. Note that all flowtube (102) designs, as resonant mechanical systems, have multiple vibration modes (labeled herein as 1, . . . , N). In a single-driver design, a single driver (106) is typically located at the midpoint of the flowtube (102), i.e., at position D3 in FIG. 1. This is usually the optimal location for driving a symmetric vibration mode (also referred to here as “Coriolis mode”). Typically, the resonant frequency of an antisymmetric mode (also referred to as “Drive mode”) for a flowtube (102) of the shape shown in FIG. 1 is higher than the resonant frequency of the symmetric mode. Consequently, with a single driver (106) centrally located (i.e., at position D3 in FIG. 1) the lowest frequency (i.e., the symmetric) vibration mode may be excited. In this case, the driver (106) D3 is located at the point of highest amplitude change (i.e., at an antinode). However, for antisymmetric vibration modes, the driver (106) D3 is located close to a node, where effectively no motion occurs. Accordingly, it may not be possible for this driver configuration to generate and regulate antisymmetric vibration modes.

A two-driver design (e.g., with drivers (106) located at positions D1 and D2 in FIG. AAA) may be able to drive the flowtube (102) in either the symmetric or antisymmetric modes independently or in both symmetric and antisymmetric modes simultaneously. However, the total drive current supplied to the drivers (106) has intrinsic safety limits. For example, as previously stated, two-phase flows (e.g., gas/liquid) passing through the flowtube (102) may cause high and variable damping on the flowtube (102), requiring high drive currents and a fast response of the Coriolis transmitter (108). When only two drivers (106) are provided (e.g., two drivers located at positions D1 and D2 in FIG. 1) and where two vibration modes are to be maintained, the Coriolis transmitter (108) must decide how much current to assign to each mode such that both vibration modes are kept in operation, while ensuring the overall drive current does not exceed the intrinsic safety limits. This is generally difficult to achieve and typically one mode is maintained while the other mode stops operating.

In accordance with one or more embodiments, the prototype of the present invention uses a three-driver design (located, for example, at positions D1, D2, and D3 in FIG. 1, with sensors located at positions S1 and S2) operating between two parallel tubes arranged in series is used to independently maintain the symmetric and antisymmetric vibration modes. That is, the driver (106) located at position D3 in FIG. 1 is used to drive at least one symmetric mode, and the drivers (106) located at positions D1 and D2 are used to drive at least one antisymmetric mode. The addition of a third driver increases the energy that may be used to maintain flowtube (102) operation without violating intrinsic safety limits. This may lead to better flowtube (102) control, a higher amplitude of oscillation, and a better signal-to-noise ratio than would be otherwise possible with a single-or two-driver design.

As previously stated, the operation of a multimode Coriolis flow meter (100) is dependent upon the proper oscillation of the flowtube (102). Rapid changes in damping, frequency, amplitude, and phase of the sensor signals require fast and accurate tracking by the Coriolis transmitter (108) to generate an appropriate drive signal. If the drive control update rate is too slow, or if there is too much time before nominal performance is restored, the flowtube (102) may cease vibrating entirely (i.e., stalling). Alternatively, if the oscillation is maintained, inaccurate tracking may lead to a phase shift between input and output, leading to forced oscillation where the drive frequency drifts away from its natural value. In the high damping conditions of a multiphase flow, this may be difficult to detect and correct. Consequently, the Coriolis transmitter (108) requires a highly responsive drive control system to maintain oscillation of the flowtube (102) in the desired vibration modes during multiphase flow operation.

Keeping with FIG. 1, the Coriolis transmitter (108) transmits one or more drive signals to the drivers (106) to maintain oscillation of the flowtube (102) in the desired vibration modes. The oscillation of the flowtube (102) is sensed by the sensors (104) and is typically sinusoidal. The Coriolis transmitter (108) is configured to receive the sensor signals and determine the frequency, amplitude, and phase for each vibration mode. Given that the multimode Coriolis flow meter (100) uses one or more sensors (104) to monitor the same flowtube (102), each sensor signal contains a sum of components corresponding to each mode of vibration.

The signal processing technique enabling the separation and tracking of the multiple vibration modes falls under the general category of Prism signal processing (Precise, Repeat Integral Signal Monitor). The requirements for a digital Coriolis drive system are well known to those skilled in the art. Typical steps may include: converting the latest sensor (104) signals into digital values using two or more channels of analog-to-digital conversion; determining the current frequency, amplitude, and phase of the resonant mode using the most recent digitized recent sensor (104) data; determining, based on the current sensor (104) parameter values, the desired parameter values (frequency, phase, amplitude) of the drive output signal(s); synthesizing the desired drive output via one or more channels of digital-to-analog output; transmitting the desired drive output to the flowtube driver (106) to maintain its oscillation; and performing an analysis of the sensor (104) signals to calculate the latest values of frequency and phase and/or time difference for conversion into mass flow and density measurements. In the current invention, when more than one mode of oscillation is being operated, the parameter values must be extracted using Prism signal processing techniques for each of the resonant modes present in the sensor (104) signals, whether for the purposes of flowtube control or for process measurement.

In accordance with one or more embodiments, a 60 mm (millimeter) diameter flowtube (102) has been coupled to a prototype Coriolis transmitter (108) which drives the flowtube (102) in two oscillation modes simultaneously while calculating independent mass flow and density measurements using the data from each mode. The two modes are close to one another: the oscillation frequencies may be, for example, 83 Hz (Hertz) and 95 Hz when the flowtube (102) is filled with air, and 75 Hz & 86 Hz with the flowtube (102) is filled with water. In other words, in such an embodiment, the two modes of operation are in close proximity to one another and separated by 12 Hz and 11 Hz when the flowtube (102) is filled with air and water, respectively. Having vibration modes in such close proximity results in large phase differences with flow rate (i.e., the “measurement signal” is strong) but the signal processing challenges of separating the two modes are significant. There are also tradeoffs between noise rejection and dynamic response to be considered. As the multimode Coriolis flow meter (100) acts as a control system, the measurement of frequency, phase, and amplitude must be fast enough to enable the control system to maintain stable flowtube (102) oscillation. Conventionally, these parameters are tracked using a signal processing technique with a suitably fast dynamic response, while averages of the same values are used to provide process measurements at a slower rate.

In the current invention, different Prism-based techniques are used for flowtube control and process measurement. For process measurement, after the analog sensor (104) signals have been digitized via twin analog-to-digital converters, heterodyning is used to shift the frequency of the desired mode into the filter passband of a low-pass filter. Heterodyning is a well-known signal processing technique which shifts a target frequency to another desired frequency. In the current invention, heterodyning is used to shift the targeted sensor (104) signal component, corresponding to the desired mode of vibration to be tracked, to the peak passband frequency of the low-pass filter. As the passband is narrow, when one mode is shifted to the filter peak, the other mode falls into the filter stop band, thus ensuring there is no modal interference. In other words, the filter passband is sufficiently narrow to ensure that the targeted signal component is passed while other unwanted components are blocked. After low-pass filtering, a Prism tracker stage is implemented to provide estimates of frequency, phase, and amplitude.

While this signal processing scheme can successfully separate and derive measurement data from each of the two modes, its dynamic response is too slow to enable stable control of the flowtube (102) operating in dual mode. Accordingly, for flowtube control, an alternative Prism-based scheme may be used to generate parameter values with a faster dynamic response. This filter structure combines a Prism low-pass filter, with a wider passband, together with a dynamic notch filtering layer. Instead of using heterodyning and a narrow passband to separate the modes, dynamic notching is used, whereby a suitably weighted linear combination of parallel filter outputs can notch out one unwanted mode. In a parallel path, a different linear combination is used to notch out the other mode. Weightings can be selected in real time to match the current oscillating frequencies of the flowtube (102), such that a fixed set of filters can provide notching across the full operating range of the multimode Coriolis flow meter (100).

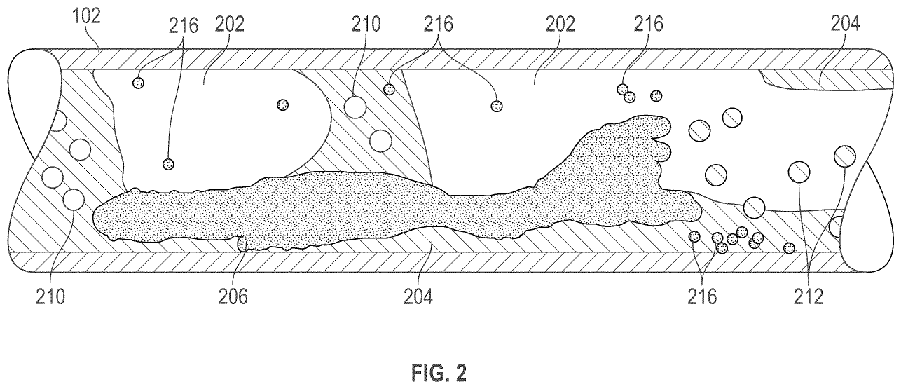

FIG. 2 depicts a simplified view of a cross-section of a flowtube (102) carrying a multiphase fluid. A multiphase fluid is composed of one or more components including, but not limited to, oil, water, and gas. For conciseness, the term multiphase is adopted throughout this disclosure, even when referring to a single-phase fluid. However, one skilled in the art will recognize that the concepts and methods detailed hereafter are not limited by this choice of nomenclature. As seen in FIG. 2, the multiphase fluid may have multiple components such as gas (202), water (204), and oil (206). The various components of the multiphase fluid may be distributed within the flowtube (102) in a myriad of ways. As a non-limiting example, gas (202) may be enclosed by liquids (water or oil) forming bubbles (210). Or, in contrast, liquid droplets, such as oil droplets (216) and water droplets (212), may be dispersed in the gas (202) to form a mist. In general, the state of the multiphase fluid may be described using broad classifications. That is, the multiphase fluid may be categorized as “slug flow,” “plug flow,” “entrained,” “bubbly,” “annular,” “churn,” “mist,” “stratified,” or other designations (flow classes) based on the distribution of the components and their relative quantities. The state of the multiphase fluid may be transient such that any assignment of flow class may change with time.

As previously stated, the multimode Coriolis flow meter (100) may be used to measure multiphase flows. For example, a “three-phase flow” or “mixed two-phase flow” refers to a situation in which immiscible liquids are mixed with a gas. For example, a flowing mixture of oil and water may contain air (or another gas), perhaps in the form of bubbles, thus forming a “three-phase flow.” Such terminology (i.e., “three-phase flow”) refers to the three components of the flow (e.g., oil, water, and gas) and generally implies that a solid material (e.g., sand) is not included in (or is filtered out) from the flow. Further, without any loss of generality, the gas component in a multiphase flow may itself be a mixture. In another example, the term “two-phase flow” may refer to a liquid and a gas. As previously noted, to the extent that the multiphase fluid flow contains gas and/or mixed liquids, the measurements output by the multimode Coriolis flow meter (100) generally represent apparent values (e.g., apparent mixture mass flow rate, apparent mixture density, etc.) which may ultimately be corrected using a correction model. Then, mass flow rates for the individual components (e.g., oil, water, and gas in a three-phase flow) of the multiphase flow may be determined.

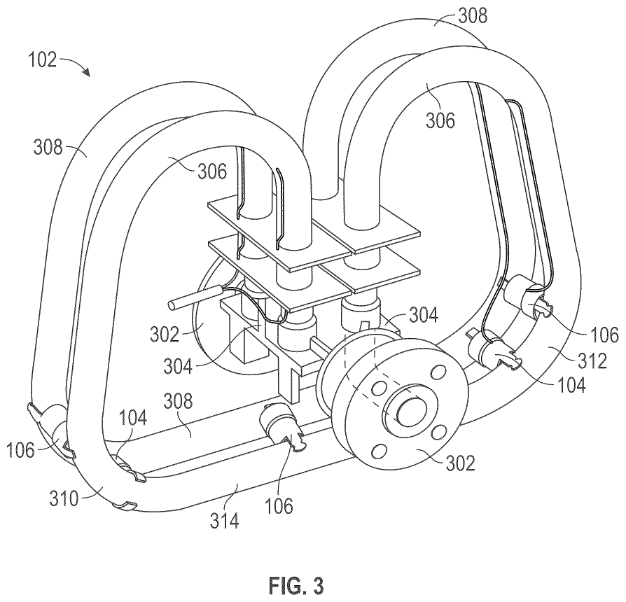

In accordance with one or more embodiments, FIG. 3 shows a detailed view of the multimode Coriolis flow meter (100) using a bent flowtube (102) design. The flowtube (102) is designed to be inserted in a pipeline (not shown) having a small section removed or reserved for the flowtube (102). The flowtube (102) includes mounting flanges (302) for connection to the pipeline, and a central manifold block (304) supporting two parallel planar loops (306) and (308) that are oriented perpendicularly to the pipeline. Electromagnetic drivers (106) and sensors (104) are attached to the flowtube (102). The entire lateral excursion of the loops at the lower rounded turns (310) and (312) is small, on the order of 1/16 of an inch for a two foot long straight section (314) of a pipe having a one inch diameter.

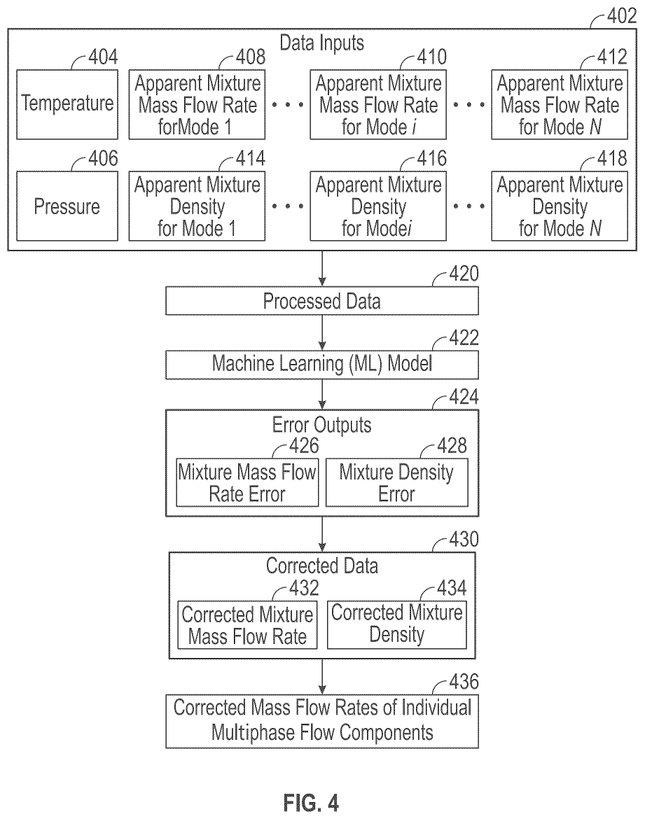

As previously stated, maintaining flowtube (102) oscillation is insufficient to ensure an accurate measurement, since multiphase fluids are known to induce potentially large errors in the apparent mass flow and density measurements generated by the multimode Coriolis flow meter (100). Specifically, a multimode Coriolis flow meter (100) may underread the apparent mixture mass flow rate and the apparent mixture density of a multiphase fluid. Although there are theoretical models (e.g., bubble model) and algorithms to correct the errors generated by a multiphase fluid, these have limited use beyond specific cases (e.g., very low GVF). In particular, the flowtube (102) design (which, as noted, may vary from simple straight pipes to complex bending designs, either in parallel or in series) and orientation (which influences the gas buoyancy) have a significant impact on the observed mass flow and density errors, along with certain fluid properties, such as viscosity. For example, horizontal flows may result in lower errors than vertical flows, or vice-versa. In accordance with one or more embodiments, FIG. 4 depicts a flowchart describing the process of developing and using a ML model as a correction model to compensate for errors in the apparent values and determine corrected mass flow and density measurements.

In one aspect, embodiments disclosed herein relate to the multiphase flow error correction system (114) based on a ML model (422) that predicts a mixture mass flow rate error (426) and a mixture density error (428), as discussed in greater detail below. In another aspect, the multiphase flow error correction system (114) and ML model (422) determine corrected data (430), i.e., a corrected mixture mass flow rate (432) and a corrected mixture density (434). It should be noted that the correction applied to obtain the corrected mixture mass flow rate (432) may be different than the correction applied to obtain the corrected mixture density (434). Further, the multiphase flow error correction system (114) and ML model (422) automatically determine corrected mass flow rates of the individual multiphase flow components (436) in real-time or near real-time. The multiphase flow error correction system (114) improves upon traditional methods by utilizing the independent measurements from each vibration mode (i=1, . . . , N) to correct the apparent mixture mass flow rate and apparent mixture density of the multiphase flow.

In accordance with one or more embodiments, independent measurements from each vibration mode (i=1, . . . , N) may be used for cross-validation. For example, as previously stated, given that the multimode Coriolis flow meter (100) uses one or more sensors (104) to monitor the same flowtube (102), spectral analysis of the sensor (104) signals may be compared against one another for self-validation and diagnostics of the multimode Coriolis flow meter (100) operation. In another embodiment of the present invention, independent measurements from each vibration mode (i=1, . . . , N) may be used to identify features present in the spectral analysis of the sensor (104) signals. For example, spectral peaks may provide information regarding the resonant characteristics of the flowtube (102) (e.g., driven modes frequencies, beat modes frequencies, relative positions and amplitudes of undriven modes, etc.) and its interaction with the environment (e.g., power line frequency, externally-induced vibrations, etc.).

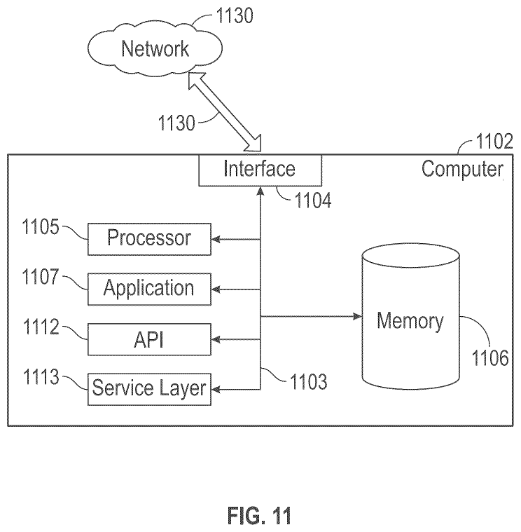

In some embodiments, the multimode Coriolis flow meter (100) includes the multiphase flow error correction system (114). For example, the multiphase flow error correction system (114) may include hardware and/or software with functionality for determining corrected data (430) (i.e., a corrected mixture mass flow rate (432) and a corrected mixture density (434)) and automatically generating corrected mass flow rates of the individual multiphase flow components (436) in real-time or near real-time. That is, the multimode Coriolis flow meter (100) is operable to determine individual flow rates of the flow components, as opposed to determining the flow rate of the combined multiphase flow. For this purpose, the system may include memory with one or more data structures, such as a buffer, a table, an array, or any other suitable storage medium. In some embodiments, the multiphase flow error correction system (114) may include a computer system similar to the computer system (1102) described below with regard to FIG. 11 and the accompanying description. While the multiphase flow error correction system (114) is shown located at the same site as the multimode Coriolis flow meter (100) in FIG. 1, in some embodiments, the multiphase flow error correction system (114) may be located remotely from the multimode Coriolis flow meter (100).

Once the ML model (422) has been trained, it may be used “in production”, which means a trained ML model is used to process a received input without having a paired target for comparison, to provide a corrected mixture mass flow rate (432) and a corrected mixture density (434) based on which corrected mass flow rates of the individual multiphase flow components (436) may be automatically determined in real-time or near real-time.

Initially, data inputs (402) obtained from a plurality of sources are processed to obtain processed data (420) and are received by the ML model (422). In accordance with one or more embodiments, the data inputs (402) may include temperature (404), pressure (406), apparent mixture mass flow rate for each vibration mode, and apparent mixture density for each vibration mode. Temperature (404) and pressure (406) data may be obtained using, for example, the temperature sensor (112) and the pressure sensor (110). Specifically, apparent mixture mass flow rate for each vibration mode may include apparent mixture mass flow rate for mode 1 (408), apparent mixture mass flow rate for mode i (410), and apparent mixture mass flow rate for mode N (412), where i=1, . . . , N. Apparent mixture density for each vibration mode may include apparent mixture density for mode 1 (414), apparent mixture density for mode i (416), and apparent mixture density for mode N (418), where i=1, . . . , N. In one or more embodiments, the data inputs (402) may be obtained in real-time or near real-time. Generally, and as will be described later in the instant disclosure, processing comprises, at a minimum, altering the data inputs (402) so that they are suitable for use with ML models. One with ordinary skill in the art will appreciate that other factors and parameters that are not necessarily shown in FIG. 4 may be used as data inputs (402).

In accordance with one or more embodiments, after processing the data inputs (402) to obtain processed data (420), the processed data (420) is inputted into the ML model (422) and the ML model (422) outputs the error outputs (424). These errors may include, for example, a mixture mass flow rate error (426) and a mixture density error (428). The mixture mass flow rate error (426) generally refers to the deviation of the apparent mixture mass flow rate (e.g., apparent mixture mass flow rate for mode i (410)) from the true mixture mass flow rate. Similarly, the mixture density error (428) generally refers to the deviation of the apparent mixture density (e.g., apparent mixture density for mode i (416)) from the true mixture density. In general, the mixture mass flow rate error (426) and the mixture density error (428) may be expressed as percentage errors of the true values.

In laboratory experiments the mixture mass flow rate error (426) and the mixture density error (428) may be determined based on known multiphase flows (e.g., air/water flow, oil/water/nitrogen flow, etc.). For example, a phase separator, a weigh scale, and one or more single-phase meters may be used to determine the mixture mass flow rate error (426) and the mixture density error (428) by comparison with the apparent mixture mass flow rate and apparent mixture as determined by the multimode Coriolis flow meter (100).

In accordance with one or more embodiments, if the water cut is known, for example by the provision of a water cut reading, the generation of mass flow and/or density measurements from multiple modes of vibration results in improved corrections compared with only having data from a single mode of vibration, as previously stated. In such embodiment, it is assumed that the water and oil densities are known (including, where appropriate, coefficients for temperature variation, etc.). In addition, it is assumed that the current water cut is known (for example by using a water cut meter capable of operating correctly with oil/water/gas mixtures). In the present invention the water cut measurement plays a dual role, both as a model input, but also in the calculation of the density drop, which provides a liquid-density-independent indicator of gas content and can be thought of as the apparent GVF. If there were no errors, the density drop would be the same as the GVF. The density drop is a useful parameter because it provides independence from the particular liquid density for the correction model, which can then be used for a variety of liquids. Given the water cut as a percentage measure, the liquid-only mixture density ρₗ (i.e., the gas-free oil and water mixture density) is mathematically given by:

$${ρ}_{l} = \frac{WC}{100} {ρ}_{w} + ( 1 - \frac{WC}{100} ) {ρ}_{o} \qquad ( Equation 1 )$$

where ρ_{w} and ρₒ are the densities of the water (w) and oil (o), respectively, and WC is the water cut.

The density drop (dd) is then defined as the difference between the apparent mixture density ρₘₐ (e.g., the apparent mixture density for mode i (416)) as determined by the multimode Coriolis flow meter (100) and the liquid-only mixture density ρₗ, expressed as a percentage:

$$dd = 100 \frac{( {ρ}_{l} - {ρ}_{ma} )}{{ρ}_{l}} \qquad ( Equation 2 )$$

In accordance with one or more embodiments, if two independent mass flow measurements are available simultaneously with different error characteristics, the new correction models can be built using both apparent mass flow measurements. For example, models can be created with four inputs: the water cut WC, the density drop dd from a specific mode of vibration, the Coriolis mode mass flow rate, and the Drive mode mass flow rate. The resulting error estimates are used to generate corrected values of the density and mass flow measurements (i.e., corrected data (430)) which provides sufficient information to derive the flowrates of each of the individual phases.

In accordance with one or more embodiments, if the water cut is not known, the water cut may be estimated based on the available data from multiple modes of vibration, before proceeding with calculations of the corrected data (430). Specifically, if the water cut measurement is not available, this removes two of the parameters used in the earlier models: the water cut WC itself, but also the density drop dd, which, as explained above, requires knowledge of the liquid-only mixture density. Note also that knowledge of the water cut is a requirement for later stages in the calculation to separate out the water and oil flow rates. Accordingly, different modelling approaches are required for this case, which must include estimating the true water cut. An alternative to the previously defined density drop dd is the water density drop dd_{w}, which can be mathematically defined as the drop in the observed density compared to the known density of the water component only:

$${dd}_{w} = 100 \frac{( {ρ}_{w} - {ρ}_{ma} )}{{ρ}_{w}} \qquad ( Equation 3 )$$

The water density drop dd_{w} parameter combines the effect of the unknown water cut, the unknown gas content, and the density error induced by the gas/liquid mixture.

An algorithm to determine the best estimate of water cut is set out as follows:
1. Select a range of WC values (e.g., 0 to 100)
2. For each value in the selected water cut range, WC_{guess}:
   a. Calculate dd_{guess}.
   b. Predict Coriolis mode mass flow error.
   c. Predict true mass flow rate based on Coriolis mass flow error model.
   d. Predict Drive mode mass flow error.
   e. Predict true mass flow rate based on Drive mass flow error model.
   f. Calculate a mass flow difference as the percentage difference between the two estimates of the true mass flow rate.
   g. Predict the true differential pressure across the flowtube.
   h. Calculate a differential pressure offset as the difference between the predicted and actual differential pressure.
   i. Calculate a best fit function for WC_{guess} using the mass flow difference and the differential pressure offset.
3. Select the WC_{guess} value with the smallest best fit function value.
4. Based on the selected WC value, calculate dd using Equations (1)-(2) above, and proceed with a calculation of corrected mass flow and density (i.e., corrected data (430)) based on the best available models using both apparent mass flow values.

Keeping with FIG. 4, in accordance with one or more embodiments, the ML model (422) allows for calculations of the corrected data (430). Then, corrected mass flow rates of individual multiphase flow components (436) (e.g., oil, water, and gas in a three-phase flow) may be automatically determined in real-time or near real-time using the corrected mixture mass flow rate (432) and the corrected mixture density (434).

While embodiments disclosed herein are presented with respect to a ML correction model, those skilled in the art will appreciate other correction models may be used. For example, in some embodiments, the correction model may be a multivariable polynomial model. Further, those familiar with the art will appreciate that alternative and/or additional modelling parameters, such as the pressure drop across the flowtube, and/or the drive gain for one or both modes of vibration, may also be used.

Embodiments of the present disclosure may provide at least one of the following advantages. As previously stated, multiphase flows induce potentially large, variable, but repeatable errors in the apparent mixture mass flow rate and apparent mixture density measurements. The mixture mass flow rate error (426) and the mixture density error (428) may depend on many factors, such as, for example, meter size (e.g., flowtube diameter, etc.), orientation (e.g., horizontal, vertical, etc.), type (e.g., straight flowtube, bent flowtube, etc.), and flow properties, including flow regime (e.g., slug flow, plug flow, etc.), viscosity, and pressure. Embodiments disclosed herein drive the flowtube (102) to operate in one or more different vibration modes simultaneously and provide mass flow and density measurements from each mode of vibration, which may have different error characteristics, thus enabling improved error correction and/or error correction when the true water cut is not provided by additional instrumentation.

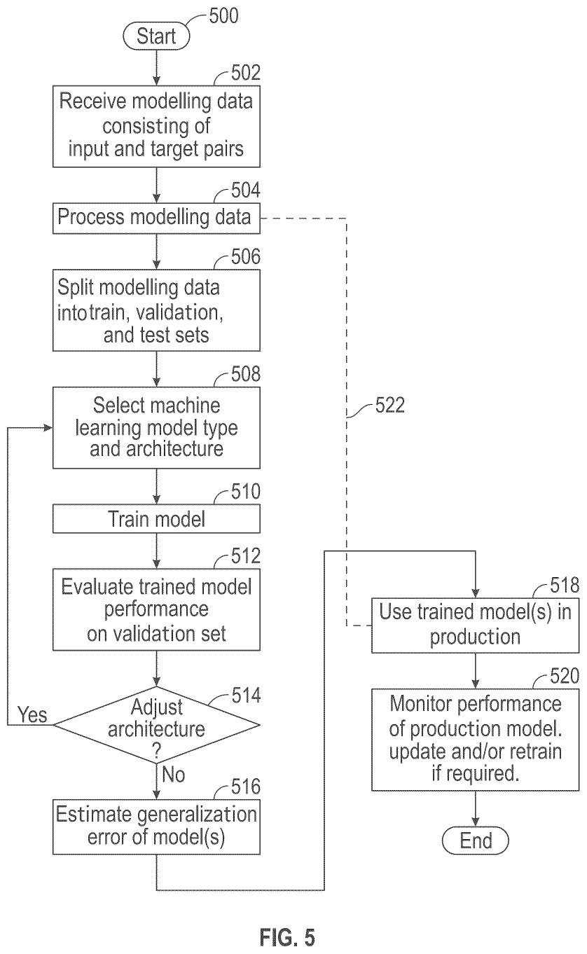

FIG. 5 depicts the general process of selecting and training the ML model, in accordance with one or more embodiments. The process shown in FIG. 5 may be applied to obtain a trained ML model. To start, as shown in Block 502, modelling data is received. The modelling data consists of input and target pairs. For example, to train the ML model (422), an input and target pair may consist of data inputs (402) and error outputs (424). In accordance with one or more embodiments, the data inputs (402) may include temperature (404), pressure (406), apparent mixture mass flow rate for each vibration mode (e.g., apparent mixture mass flow rate for mode i (410), where i=1, . . . , N), and apparent mixture density for each vibration mode (e.g., apparent mixture density for mode i (416), where i=1, . . . , N). In one or more embodiments, the temperature (404) and pressure (406) data may be obtained using, for example, the temperature sensor (112) and the pressure sensor (110). Error outputs (424) may include, for example, a mixture mass flow rate error (426) and a mixture density error (428).

Returning to FIG. 5, in one or more embodiments, the modelling data is processed as depicted by Block 504. As previously stated, processing comprises, at a minimum, altering the modelling data so that it is suitable for use with ML models. For example, processing may include numericizing categorical data or removing data entries with missing values. Other typical processing methods are normalization and subsampling. Subsampling is a method that reduces data size by selecting a subset of the original data. In general, information surrounding the processing steps is saved for potential later use. For example, if normalization is performed then a computed mean vector and variance vector are retained. This allows future modelling data to be processed identically. Values computed and retained during processing are referred to herein as processing parameters. One with ordinary skill in the art will recognize that a myriad of processing methods beyond numeration, removal of modelling data entries with missing values, normalization, and subsampling exists. Descriptions of a select few processing methods herein do not impose a limitation on the processing steps encompassed by this disclosure.

As shown in Block 506, the modelling data is split into training, validation, and test sets. In some embodiments, the validation and test set may be the same and the data is effectively only split into two distinct sets. In some instances, Block 506 may be performed before Block 504. In this case, it is common to determine the processing parameters, if any, using the training set and then to apply these parameters to the validation and test sets.

In Block 508, the ML model type and associated architecture is selected. Once selected, the ML model is trained using the training set of the modelling data according to Block 510. Common training techniques, such as early stopping, adaptive or scheduled learning rates, and cross-validation may be used during training without departing from the scope of this disclosure.

ML model types may include, but are not limited to, K-means clustering, K-nearest neighbors, neural networks, logistic regression, random forests, generalized linear models, and Bayesian regression. Also, ML encompasses model types that may further be categorized as “supervised,” “unsupervised,” “semi-supervised,” or “reinforcement” models. One with ordinary skill in the art will appreciate that additional or alternate ML model categorizations may be defined without departing from the scope of this disclosure. Constraining a model to make it simpler and reduce the risk of overfitting is called regularization. The amount of regularization to be applied during learning may be controlled by “hyperparameters” which further describe the ML model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.” Generally, multiple model types and associated hyperparameters are tested and the model type and hyperparameters that yield the greatest predictive performance on a hold-out set of data is selected. Greater detail regarding the ML models, in accordance with one or more embodiments, will be provided below in the present disclosure.

During training, or once trained, the performance of the trained ML model is evaluated using the validation set as depicted in Block 512. Recall that, in some instances, the validation and test sets are the same. Generally, performance is measured using a function which compares the predictions of the trained ML model to the given targets. A commonly used comparison function is the mean-squared-error function, which quantifies the difference between the predicted value and the actual value when the predicted value is continuous. However, one with ordinary skill in the art will appreciate that many more comparison functions exist and may be used without limiting the scope of the present disclosure.

Block 514 represents a decision: if the trained ML model performance, as measured by a comparison function on the validation set (Block 512), is not suitable, the ML model architecture may be altered (i.e., return to Block 508) and the training process is repeated. There are many ways to alter the ML model architecture in search of suitable trained ML model performance. These include, but are not limited to: selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete, and the generalization error of the trained ML model is estimated according to Block 516.

Generalization error is an indication of the trained ML model's performance on new, or un-seen data. Typically, the generalization error is estimated using the comparison function, as previously described, using the modelling data that was partitioned into the test set.

As depicted in Block 518, the trained ML model is used “in production”, which means, as previously stated, that the trained ML model is used to process a received input without having a paired target for comparison. It is emphasized that the inputs received in the production setting, as well as for the validation and test sets, are processed identically to the manner defined in Block 504 as denoted by the connection (522), represented as a dashed line in FIG. 5, between Blocks 518 and 504.

In accordance with one or more embodiments, the performance of the trained ML model is continuously monitored in the production setting (520). If model performance is suspected to be degrading, as observed through in-production performance metrics, the model may be updated. An update may include retraining the model, by reverting to Block 508, with the newly acquired modelling data from the in-production recorded values appended to the training data. An update may also include recalculating any processing parameters, again, after appending the newly acquired modelling data to the existing modelling data.

While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Gradient boosting is an ensemble learning method used in ML that creates a predictive model by combining the predictions of several multiple “weak” learners to create a “strong” predictive model. The basic idea behind a gradient boosting algorithm is to iteratively add learners to correct the errors of the previous learners in the ensemble. At each iteration, a new “weak” learner model is trained with respect to the error of the entire ensemble. The goal of the algorithm is to find a function F(x) that best approximates the target variable (e.g., the error outputs (424)) from the input variables (e.g., temperature (404), pressure (406), apparent mixture mass flow rate for each vibration mode (e.g., apparent mixture mass flow rate for mode i (410), where i=1, . . . , N), and apparent mixture density for each vibration mode (e.g., apparent mixture density for mode i (416), where i=1, . . . , N)), such that ŷ=F(x).

While a full review of gradient boosting exceeds the scope of this disclosure, a brief summary is provided. Consider a training set

$${\{ ( {x}_{i} , {r}_{im} ) \}}_{i = 1}^{n} ,$$

a differentavie ross function L(yᵢ, F(xᵢ)), and a gradient boosting algorithm with M stages. The predicted error outputs (424) for the i-th observation at the m-th stage is denoted as Fₘ(xᵢ). The algorithm starts by initializing the model with a constant value γ:

$${F}_{0} ( x ) = {arg min}_{γ} {\sum }_{i = 1}^{n} L ( {y}_{i} , γ ) \qquad ( Equation 4 )$$

where the term “arg min” is a mathematical notation that represents the value of γ at which the minimum value of

$${\sum }_{i = 1}^{n} L ( {y}_{i} , γ )$$

is achieved. For example, for a mean-squared-error loss function the initial model predicts

$${F}_{0} ( x ) = \frac{1}{n} {\sum }_{i = 1}^{n} {y}_{i}$$

, i.e., the mean of the target values.

At each subsequent m=1 to m=M stage, the algorithm computes the pseudo-residuals:

$${r}_{im} = - {[ \frac{\partial L ( {y}_{i} , F ( {x}_{i} ) )}{\partial F ( {x}_{i} )} ]}_{F ( x ) = {F}_{m - 1} ( x )} , for i = 1 , ... , n \qquad ( Equation 5 )$$

For example, for a mean-squared-error loss function the pseudo-residuals rᵢₘ are the difference between the target and predicted error outputs (424) (i.e., rᵢₘ=yᵢ−Fₘ₋₁).

Further, the algorithm fits a base learner (e.g., a decision tree) hₘ(x) to the pseudo-residuals. In other words, the base learner is trained using the

$${\{ ( {x}_{i} , {r}_{im} ) \}}_{i = 1}^{n}$$

set and chooses a multiplier γₘ that minimizes the loss function when added to the current model:

$${γ}_{m} = {arg min}_{γ} {\sum }_{i = 1}^{n} L ( {y}_{i} , {F}_{m - 1} ( {x}_{i} ) + γ {h}_{m} ( {x}_{i} ) ) \qquad ( Equation 6 )$$

The model is updated as follows:

$${F}_{m} ( x ) = {F}_{m - 1} ( x ) + {γ}_{m} {h}_{m} ( x ) \qquad ( Equation 7 )$$

The output of the algorithm is:

$${F}_{M} ( x ) = {F}_{0} ( x ) + {γ}_{1} {h}_{1} ( x ) + ... + {γ}_{M} {h}_{M} ( x ) \qquad ( Equation 8 )$$

Gradient boosting may be extended to include subsampling and regularization to improve the model's performance and prevent overfitting. Subsampling is a technique where a subset of the data is randomly selected at each iteration before fitting the base learner. This may improve performance and help prevent overfitting by adding randomness into the model building process. Regularization is a technique used to prevent overfitting by adding a penalty term to the loss function that discourages complex models. In the context of gradient boosting, regularization is often applied by shrinking the predictions of each base learner by a factor of 0<λ≤1 and by limiting the complexity of the base learners. The gradient boosting algorithm with subsampling and regularization starts with initializing the model with a constant value γ:

$${F}_{0} ( x ) = {arg min}_{γ} {\sum }_{i = 1}^{n} L ( {y}_{i} , γ ) \qquad ( Equation 9 )$$

Further, for at each subsequent m=1 to m=M stage, a subsample Sₘ is drawn without replacement from the training data and the pseudo-residuals for the subsample Sₘ are computed as follows:

$${r}_{im} = - {[ \frac{\partial L ( {y}_{i} , F ( {x}_{i} ) )}{\partial F ( {x}_{i} )} ]}_{F ( x ) = {F}_{m - 1} ( x )} , for i in {S}_{m} \qquad ( Equation 10 )$$

A base learner (e.g., a decision tree) hₘ(x) is fitted to the pseudo-residuals and a multiplier γₘ is chosen so that it minimizes the loss function when added to the current model:

$${γ}_{m} = {arg min}_{γ} {\sum }_{i} L ( {y}_{i} , {F}_{m - 1} ( {x}_{i} ) + γ {h}_{m} ( {x}_{i} ) ) \qquad ( Equation 11 )$$

The model is updated by shrinking the predictions of each base learner by a factor λ:

$${F}_{m} ( x ) = {F}_{m - 1} ( x ) + {λγ}_{m} {h}_{m} ( x ) \qquad ( Equation 12 )$$

The output of the algorithm is:

$${F}_{M} ( x ) = {F}_{0} ( x ) + {λγ}_{1} {h}_{1} ( x ) + … + {λγ}_{M} {h}_{M} ( x ) \qquad ( Equation 13 )$$

In this version of the algorithm, each base learner is fit to a random subsample of the data, and the predictions of each base learner are shrunk by a factor of λ. This may help to improve the model's performance and prevent overfitting.

In some embodiments, the selected ML model type is a gradient boosted trees classifier. Generally, a gradient boosted trees classifier is an ensemble of decision trees. A decision tree is composed of nodes. A decision is made at each node such that data present at the node are segmented. Typically, at each node, the data at said node, are split into two parts, or segmented bimodally, however, multimodal segmentation is possible. The segmented data may be considered another node and may be further segmented. As such, a decision tree represents a sequence of segmentation rules. The segmentation rule (or decision) at each node is determined by an evaluation process. The evaluation process usually involves calculating which segmentation scheme results in the greatest homogeneity or reduction in variance in the segmented data. A detailed description of this evaluation process, or other potential segmentation scheme selection methods, is omitted for brevity and does not limit the scope of the present disclosure.

Further, if at a node in a decision tree, the data are no longer to be segmented, that node is said to be a “leaf node.” Commonly, values of data found within a leaf node are aggregated, or further modeled, such as by a linear model, so that a leaf node represents a class. The class of a leaf node will hereinafter be referred to as the assigned class of the leaf node. A decision tree may be configured in a variety of ways, such as, but not limited to, choosing the segmentation scheme evaluation process, limiting the number of segmentations, and limiting the number of leaf nodes. Generally, when the number of segmentations or leaf nodes in a decision tree is limited, the decision tree is said to be a “weak learner.” In most implementations, the decision trees from which a gradient boosted trees classifier is composed are “weak” learners. Additionally, for a gradient boosted trees classifier, the decision trees are ensembled in series, wherein each decision tree makes a weighted adjustment to the output of the preceding decision trees in the series. The process of ensembling decision trees in series, and making weighted adjustments, to form a gradient boosted trees classifier is best illustrated by considering the training process of a gradient boosted trees classifier.

The following description of the gradient boosted trees training process assumes that properly formatted training data (after normalization, subsampling, etc.), which contains both the data inputs (402) and the desired output data (or target data, or “targets”) (e.g., error outputs (424)), are supplied. Training a gradient boosted trees classifier consists of the selection of segmentation rules for each node in each decision tree; that is, training each decision tree. Once trained, a decision tree is capable of processing data. For example, a decision tree may receive a data input (402). The data input is sequentially transferred to nodes within the decision tree according to the segmentation rules of the decision tree. Once the data input is transferred to a leaf node, the decision tree outputs the assigned class of the associated leaf node.

Generally, training a gradient boosted classifier consists of making a simple prediction (SP) for the target data. The SP may the most frequent class of the target data, or the log odds or cross-entropy of the frequency of classes in the target data. The SP is subtracted from the targets to form a first residuals. The first decision tree in the series is created and trained, wherein the first decision tree attempts to predict the first residuals forming first residual predictions. The first residual predictions from the first decision tree are scaled by a scaling parameter. In the context of gradient boosted trees, the scaling parameter is known as the “learning rate” (η). In general, as previously stated, constraining a model to make it simpler and reduce the risk of overfitting is called regularization. The amount of regularization to be applied during learning may be controlled by “hyperparameters.” The learning rate is one of the hyperparameters governing the behavior of the gradient boosted trees regressor. The learning rate (η) may be fixed for all decision trees or may be variable or adaptive. The first residual predictions of the first decision tree are multiplied by the learning rate (η) and added to the SP to form a first predictions. The first predictions are subtracted from the targets to form a second residuals. A second decision tree is created and trained using the data inputs and the second residuals as targets such that it produces second residual predictions. The second residual predictions are multiplied by the learning rate (η) and are added to the first predictions forming second predictions. This process is repeated recursively until a termination criterion is achieved. Many termination criteria exist and are not all enumerated here for brevity. Common termination criteria terminate training when a pre-defined number of decision trees has been reached, or when improvement in the residuals is no longer observed.

Once trained, a gradient boosted trees classifier may make predictions using data inputs (402). To do so, the data inputs (402) are passed to each decision tree, which will form a plurality of residual predictions. The plurality of residual predictions is multiplied by the learning rate (η), summed across every decision tree, and added to the SP formed during training to produce the gradient boosted trees predictions. In some instances, a conversion is required to convert the output of the gradient boosted trees prediction to a class assignation.

One with ordinary skill in the art will appreciate that many adaptions may be made to gradient boosted trees and that these adaptions do not exceed the scope of this disclosure. Some adaptions may be algorithmic optimizations, efficient handling of sparse data, use of out-of-core computing, and parallelization for distributed computing. In accordance with one or more embodiments, the selected ML model type is an adapted gradient boosted trees model known as XGBoost.

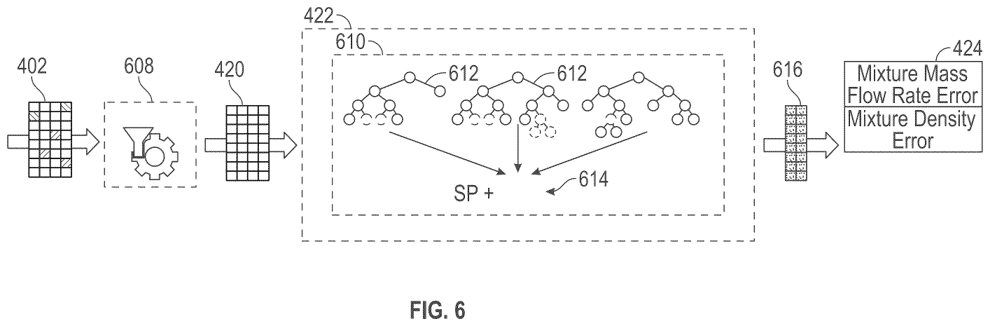

FIG. 6 depicts, generally, the flow of data through a trained gradient boosted trees classifier in accordance with one or more embodiments. As seen, data inputs (402) are received. The data inputs (402) may include temperature (404), pressure (406), apparent mixture mass flow rate for each vibration mode (e.g., apparent mixture mass flow rate for mode i (410), where i=1, . . . , N), and apparent mixture density for each vibration mode (e.g., apparent mixture density for mode i (416), where i=1, . . . , N) to be processed by the gradient boosted trees classifier. The data inputs (402) are processed (608) as previously described. The result of the processing is processed data (420) (e.g., normalized data).

The processed data (420) is passed to a ML model (422). In FIG. 6, the ML model (422) is further represented as a gradient boosted trees classifier (610) composed of a plurality of decision trees (612). As such, the processed data (420) is processed by each decision tree (612) and the output of each decision tree is collected, multiplied by the learning rate (η), summed, and added to the SP established during training, forming an ensemble prediction (614). The result of the ensemble prediction (614) is returned as the ML model prediction (616).

Depending on the configuration of the gradient boosted trees classifier (610), the ML model prediction (616) may take various forms. For example, the ML model prediction (616) may return error outputs (424), including the mixture mass flow rate error (426) and mixture density error (428), and determine corrected data (430). The corrected mixture mass flow rate (432) and the corrected mixture density (434) obtained from the ML model prediction (616) may be converted to corrected mass flow rates of the individual multiphase flow components (436).

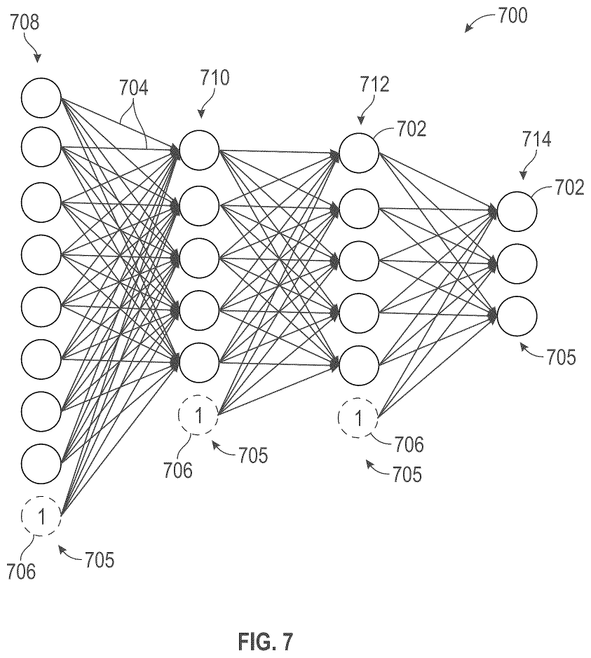

In accordance with one or more embodiments, the ML model (422) discussed herein may be a neural network. A diagram of a neural network is shown in FIG. 7. At a high level, a neural network (700) may be graphically depicted as being composed of nodes (702), where here any circle represents a node, and edges (704), shown here as directed lines. The nodes (702) may be grouped to form layers (705). FIG. 7 displays four layers (708, 710, 712, 714) of nodes (702) where the nodes (702) are grouped into columns, however, the grouping need not be as shown in FIG. 7. The edges (704) connect the nodes (702). Edges (704) may connect, or not connect, to any node(s) (702) regardless of which layer (705) the node(s) (702) is in. That is, the nodes (702) may be sparsely and residually connected. A neural network (700) will have at least two layers (705), where the first layer (708) is considered the “input layer” and the last layer (714) is the “output layer.” Any intermediate layer (710, 712) is usually described as a “hidden layer.” A neural network (700) may have zero or more hidden layers (710, 712) and a neural network (700) with at least one hidden layer (710, 712) may be described as a “deep” neural network or as a “deep learning method.” In general, a neural network (700) may have more than one node (702) in the output layer (714). In this case, the neural network (700) may be referred to as a “multi-target” or “multi-output” network.

Nodes (702) and edges (704) carry additional associations. Namely, every edge is associated with a numerical value. The edge numerical values, or even the edges (704) themselves, are often referred to as “weights” or “parameters.” While training a neural network (700), numerical values are assigned to each edge (704). Additionally, every node (702) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) \qquad ( Equation 14 )$$

where i is an index that spans the set of “incoming” nodes (702) and edges (704) and f is a user-defined function. Incoming nodes (702) are those that, when viewed as a graph (as in FIG. 7), have directed arrows that point to the node (702) where the numerical value is being computed. Some functions for f may include the linear function f(x)=x, sigmoid function

$$f ( x ) = \frac{1}{1 + {e}^{- x}} ,$$

and rectified linear unit function f(x)=max(0, x), however, many additional functions are commonly employed. Every node (702) in a neural network (700) may have a different associated activation function. Often, as a shorthand, activation functions are described by the function f by which it is composed. That is, an activation function composed of a linear function f may simply be referred to as a linear activation function without undue ambiguity.

When the neural network (700) receives an input, the input is propagated through the network according to the activation functions and incoming node (702) values and edge (704) values to compute a value for each node (702). That is, the numerical value for each node (702) may change for each received input. Occasionally, nodes (702) are assigned fixed numerical values, such as the value of 1, that are not affected by the input or altered according to edge (704) values and activation functions. Fixed nodes (702) are often referred to as “biases” or “bias nodes” (706), displayed in FIG. 7 with a dashed circle.

In some implementations, the neural network (700) may contain specialized layers (705), such as a normalization layer, or additional connection procedures, like concatenation. One skilled in the art will appreciate that these alterations do not exceed the scope of this disclosure.

As noted, the training procedure for the neural network (700) comprises assigning values to the edges (704). To begin training the edges (704) are assigned initial values. These values may be assigned randomly, assigned according to a prescribed distribution, assigned manually, or by some other assignment mechanism. Once edge (704) values have been initialized, the neural network (700) may act as a function, such that it may receive inputs and produce an output. As such, at least one input is propagated through the neural network (700) to produce an output. Recall, that a given data set will be composed of inputs and associated target(s), where the target(s) represent the “ground truth,” or the otherwise desired output. In accordance with one or more embodiments, the input of the neural network are the data inputs (402) (e.g., temperature (404), pressure (406), apparent mixture mass flow rate for each vibration mode (e.g., apparent mixture mass flow rate for mode i (410), where i=1, . . . , N), and apparent mixture density for each vibration mode (e.g., apparent mixture density for mode i (416), where i=1, . . . , N)), which may be processed, and the targets are the error outputs (424) (e.g., the mixture mass flow rate error (426) and the mixture density error (428)).

The neural network (700) output is compared to the associated input data target(s). The comparison of the neural network (700) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (700) output and the associated target(s). The loss function may also be constructed to impose additional constraints on the values assumed by the edges (704), for example, by adding a penalty term, which may be physics-based, or a regularization term. Generally, the goal of a training procedure is to alter the edge (704) values to promote similarity between the neural network (700) output and associated target(s) over the data set. Thus, the loss function is used to guide changes made to the edge (704) values, typically through a process called “backpropagation.”

While a full review of the backpropagation process exceeds the scope of this disclosure, a brief summary is provided. Backpropagation consists of computing the gradient of the loss function over the edge (704) values. The gradient indicates the direction of change in the edge (704) values that results in the greatest change to the loss function. Because the gradient is local to the current edge (704) values, the edge (704) values are typically updated by a “step” in the direction indicated by the gradient. The step size is often referred to as the “learning rate” and need not remain fixed during the training process. Additionally, the step size and direction may be informed by previously seen edge (704) values or previously computed gradients. Such methods for determining the step direction are usually referred to as “momentum” based methods.

Once the edge (704) values have been updated, or altered from their initial values, through a backpropagation step, the neural network (700) will likely produce different outputs. Thus, the procedure of propagating at least one input through the neural network (700), comparing the neural network (700) output with the associated target(s) with a loss function, computing the gradient of the loss function with respect to the edge (704) values, and updating the edge (704) values with a step guided by the gradient, is repeated until a termination criterion is reached. Common termination criteria are: reaching a fixed number of edge (704) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (704) values are no longer intended to be altered, the neural network (700) is said to be “trained.”

While multiple embodiments using different ML models have been suggested, one skilled in the art will appreciate that this process of determining error outputs (424) is not limited to the listed ML models. ML models such as a random forest, support vector machines, or non-parametric methods such as K-nearest neighbors may be readily inserted into this framework and do not depart from the scope of this disclosure.

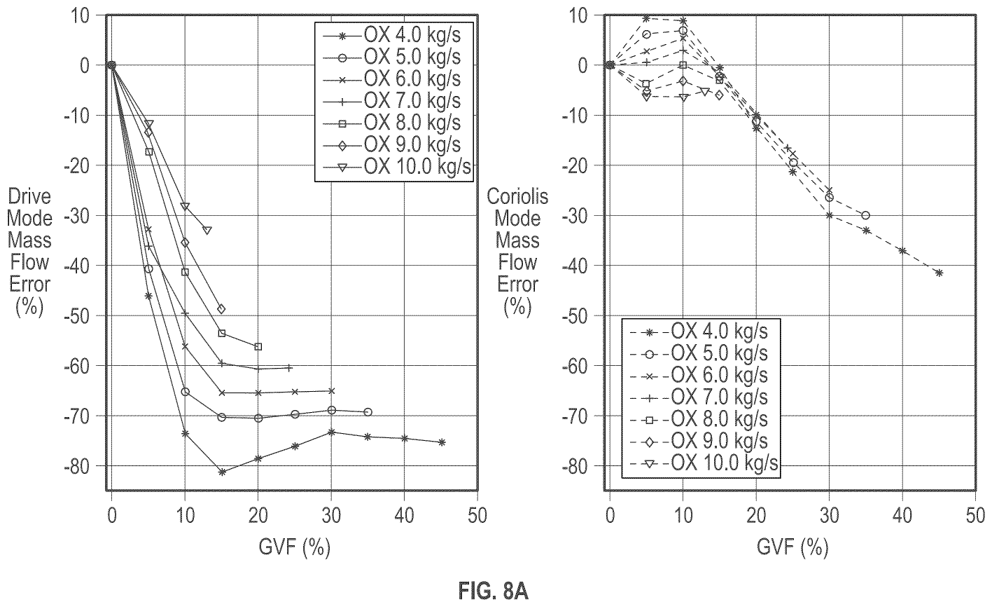

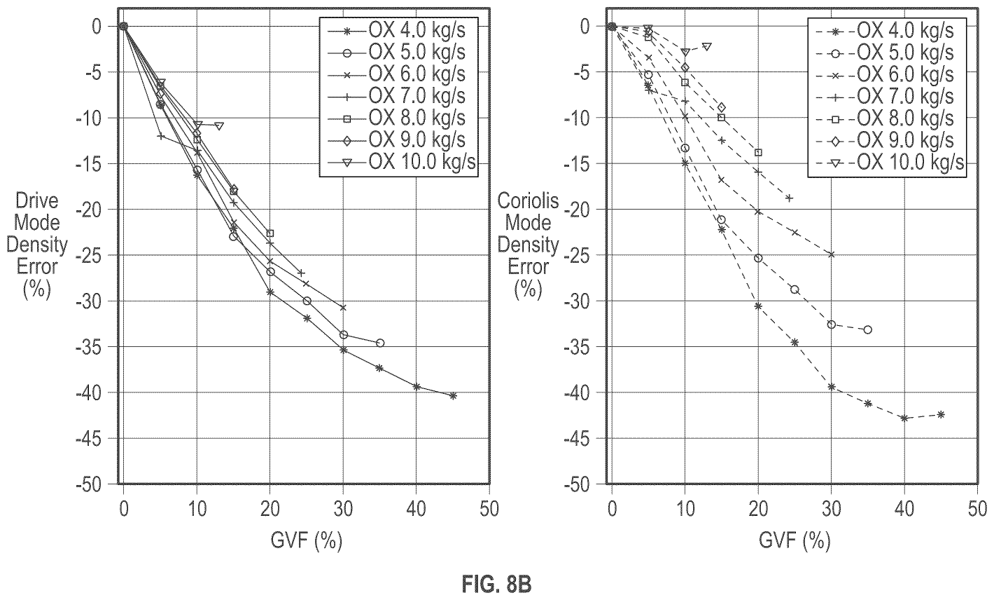

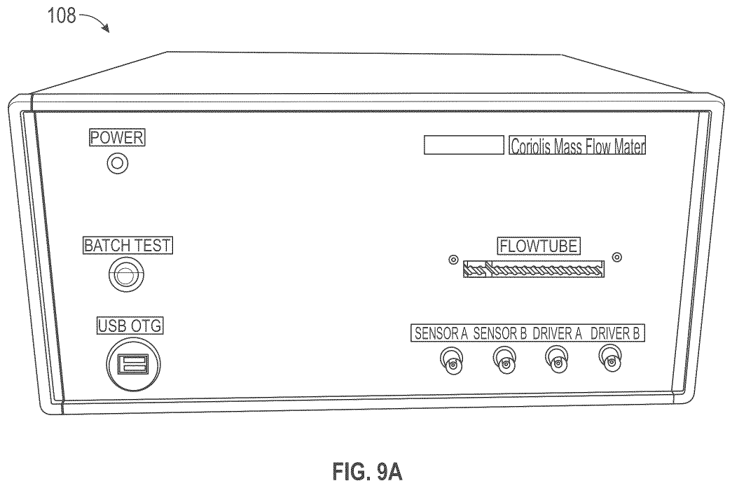

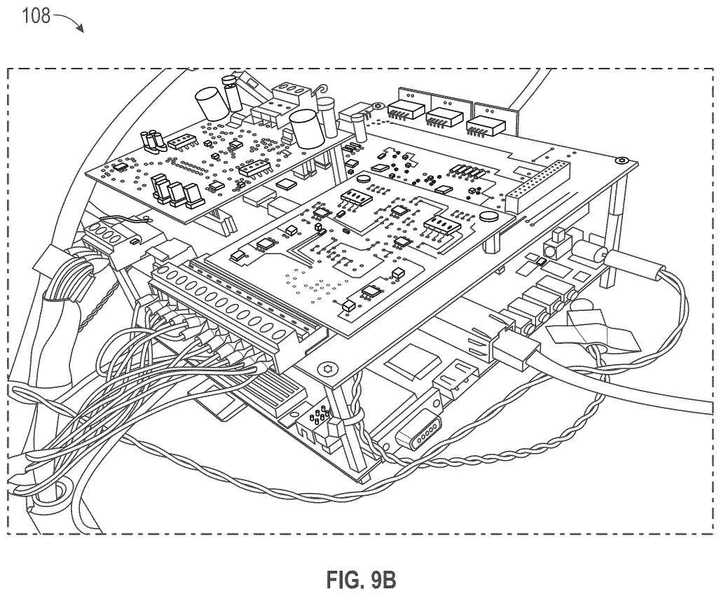

As a concrete example, FIG. 8 shows a pilot implementation of a two-mode Coriolis flow meter (100) where a custom-made flowtube (102) is filled with air/water (i.e., a two-phase flow) and coupled to a Coriolis transmitter (108). The Coriolis transmitter (108) may be the prototype Coriolis transmitter shown in FIG. 9A-9B. The Coriolis transmitter (108) drives the flowtube (102) in two vibration modes simultaneously while independently measuring the apparent mixture mass flow rate and the apparent mixture density for each vibration mode (i=1, . . . , N, where N=2 in this example). In accordance with one or more embodiments, the flowtube (102) may be driven in the two lowest vibration modes, at 75 Hz (“Coriolis mode”) and 95 Hz (“Drive mode”), respectively. Moreover, the apparent mixture mass flow rate for mode 1 (408), apparent mixture mass flow rate for mode 2 (412), apparent mixture density for mode 1 (414), and apparent mixture density for mode 2 (418) are measured.

In such an embodiment, the two vibration modes are close to each other (20 Hz). Having vibration modes in such proximity results in large phase difference measurements, i.e., a good signal-to-noise ratio. However, the signal processing challenges of separating the two modes are significant when the vibration modes are close since, in general, there is a tradeoff between noise rejection and dynamic response. In other words, as previously stated, the main challenge for multimode operation is the need for a signal processing technique capable of providing a dynamic response fast enough to enable stable flowtube (102) control, while also providing sufficient precision to deliver the required measurement performance in multiphase flow conditions. While conventional signal processing techniques may successfully separate and obtain measurement data from each of the one (or more) vibration modes, their dynamic response is too slow to enable stable control of the flowtube (102) in multimode operation. Accordingly, an alternative technique based on Prism signal processing may be used to generate measurements with a faster dynamic response, although at the expense of noise suppression. This combination of higher noise and faster dynamic response is suitable for two-mode oscillation of this custom-made flowtube (102).

Embodiments of the present disclosure may provide at least one of the following advantages. As previously stated, the flowtube (102) design (which includes the one or more drivers (106)) dictates its natural modes of resonance, and therefore what vibration modes may be induced. As a resonant mechanical system, the flowtube (102) has many modes of vibration. For example, the custom-made flowtube (102) design of the present invention has at least thirty. In general, Coriolis flow meter manufacturers have limited interest in the characteristics of modes other than the designated mode of vibration (i.e., the Drive mode) and an adjacent mode which induces the mass flow measurement (i.e., the Coriolis mode). Therefore, the viability of using other modes of vibration for pure fluid flow measurements, or multiphase flow measurements, may be more a matter of discovery than design. One reasonable expectation is that the ratio of the speed of sound to the flowtube (102) velocity (which, in turn, is determined by its vibration frequency) may have an impact on the mass flow and density errors. Consequently, it might be expected that a low frequency mode (e.g., around 100 Hz) and a high frequency mode (e.g., around 2000 Hz) may have different error characteristics, as required by this invention. However, driving the flowtube (102) at a high frequency is technically challenging, and the resulting flow measurement quality may be poor. Accordingly, embodiments disclosed herein make use of a custom-made flowtube (102) design having differentiated mass flow and density error characteristics for each vibration mode. It is possible the present invention may, in the longer term, stimulate the development of broader flowtube (102) design considerations.

Keeping with FIG. 8, initial experimental results of the pilot implementation of a two-mode Coriolis flow meter (100) over a range of water flow rates and gas content (GVF) are shown. Specifically, FIG. 8A plots the mixture mass flow rate error (426) for mode 1 (Coriolis mode) and mode 2 (Drive mode) versus GVF (e.g., α=volume of gas/(volume of liquid+volume of gas) in the case of a gas/liquid two-phase flow) at different flow rates ranging between 4.0 and 10 kg/s. FIG. 8B plots the mixture density error (428) for mode 1 (Coriolis mode) and mode 2 (Drive mode) versus GVF over the same flow range. For the avoidance of doubt, at each experimental point (flow rate, GVF), one point is generated for each of the four plots below, i.e., apparent mixture mass flow rate and apparent mixture density readings are generated for each of the modes (i=1, 2) simultaneously. The mixture mass flow rate error (426) and the mixture density error (428) are mathematically given as:

$${e}_{ma} = 100 ( \frac{{\dot{m}}_{ma} - {\dot{m}}_{mt}}{{\dot{m}}_{mt}} ) \qquad ( Equation 15 )$$

$${e}_{ma} = 100 ( \frac{{ρ}_{ma} - {ρ}_{mt}}{{ρ}_{mt}} ) \qquad ( Equation 16 )$$

where \dot{m}ₘₐ is the apparent mixture mass flow rate (e.g., the apparent mixture mass flow rate for mode i (410)), ρₘₐ is the apparent mixture density (e.g., the apparent mixture density for mode i (416)), \dot{m}ₘₜ is the true mixture mass flow rate (i.e., the actual mass flow rate of the multiphase flow), and ρₘₜ is the true mixture density (i.e., the actual density of the multiphase flow).

In FIG. 8, Prism signal processing separates and tracks the two modes (i.e., the Coriolis mode and the Drive mode) to a high precision, despite their close proximity. This facilitates good flowtube (102) control in both modes and an accurate measurement for pure liquid (not shown) and multiphase flow operation. In addition, the mass flow and density error characteristics for the two modes, as observed during initial trials using air/water, are different and strongly favorable for multiphase flow error correction. For example, while the mixture density errors (FIG. 8B) follow a similar trend for the two modes, the mixture mass flow rate errors (FIG. 8A) have very different behaviors. That is, the Drive mode (FIG. 8A, left) produces very large negative errors, while the Coriolis mode (FIG. 8A, right) produces mixture mass flow rate errors with a low magnitude and a mean value of approximately zero below 15% GVF. The provision of these independent mass flow measurements with different error characteristics enables the novel multiphase flow correction technique that forms the central innovation of the current disclosure.

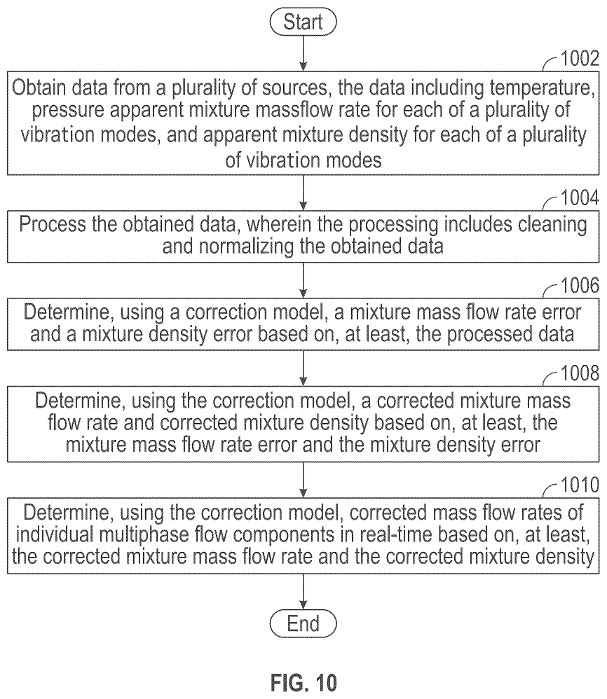

FIG. 10 depicts a method for multiphase flow error correction, in accordance with one or more embodiments. In Block 1002, data inputs (402) are obtained from a plurality of sources. The plurality of sources may include a plurality of sensors, where the sensor readings may include, at least, data about temperature (404) and pressure (406). The sensors may be used for sensing characteristics of substances passing through or otherwise located in the flowtube (102). The sensor readings may be obtained using specialized tools such as, at least, temperature sensors (e.g., resistance temperature detectors, thermocouples, etc.) and pressure gauges (e.g., bourdon tube pressure gauges, diaphragm pressure gauges, etc.) disposed at one or more locations along the flowtube (102). For example, pressure may be measured with a pressure sensor (110) located at the inlet/outlet of the flowtube (102), while the temperature may be independently measured using a temperature sensor (112) disposed along the flowtube (102).

In Block 1002, the data inputs (402) may include temperature (404), pressure (406), apparent mixture mass flow rate for each vibration mode, and apparent mixture density for each vibration mode. Temperature (404) and pressure (406) data may be obtained using, for example, the temperature sensor (112) and the pressure sensor (110). Apparent mixture mass flow rate for each vibration mode, as determined by the multimode Coriolis flow meter (100), may include apparent mixture mass flow rate for mode 1 (408), apparent mixture mass flow rate for mode i (410), and apparent mixture mass flow rate for mode N (412), where i=1, . . . , N. Apparent mixture density for each vibration mode, as determined by the multimode Coriolis flow meter (100), may include apparent mixture density for mode 1 (414), apparent mixture density for mode i (416), and apparent mixture density for mode N (418), where i=1, . . . , N. In one or more embodiments, the data inputs (402) may be obtained in real-time or near real-time.

In Block 1004, the data is processed, using a computer (1130) processor, to obtain processed data (420). Processing comprises, at a minimum, altering the data inputs (402) so that they are suitable for use with ML models. For example, processing may include numericizing categorical data or removing data entries with missing values. Other typical processing methods are normalization and subsampling. Subsampling is a method that reduces data size by selecting a subset of the original data. One with ordinary skill in the art will recognize that a myriad of processing methods beyond numeration, removal of modelling data entries with missing values, normalization, and subsampling exists. Descriptions of a select few processing methods herein do not impose a limitation on the processing steps encompassed by this disclosure.

In Block 1006, error outputs (424) based on, at least, the processed data (420) are determined using the computer (1130) processor and the ML model (422). ML model types may include, but are not limited to, K-means clustering, K-nearest neighbors, neural networks, logistic regression, random forests, generalized linear models, and Bayesian regression. Also, ML encompasses model types that may further be categorized as “supervised”, “unsupervised”, “semi-supervised”, or “reinforcement” models. Error outputs (424) may include, for example, a mixture mass flow rate error (426) and a mixture density error (428).

In Block 1008, corrected data (430) based on, at least, the mixture mass flow rate error (426) and the mixture density error (428) is determined using the computer (1130) processor and the ML model (422). Corrected data (430) may include, for example, a corrected mixture mass flow rate (432) and a corrected mixture density (434).

In Block 1010, corrected mass flow rates of individual multiphase flow components (436) based on, at least, the corrected data (430) are determined using the computer (1130) processor and ML model (422). The corrected mass flow rates of individual multiphase flow components (436) may be directly determined from the corrected mixture mass flow rate (432) and a corrected mixture density (434). In one or more embodiments, the corrected mass flow rates of individual multiphase flow components (436) may be automatically obtained in real-time or near real-time.

Embodiments may be implemented on a computer system. FIG. 11 is a block diagram of a computer system (1102) used to provide computational functionalities associated with described algorithms, methods, functions, processes, flows, and procedures as described in the instant disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the ML model (422) may be implemented on an edge computing device to quickly provide error outputs (424) and automatically determine corrected mass flow rates of the individual multiphase flow components (436) in real-time or near real-time.

Additionally, the computer (1102) may include a computer that includes an input device, such as a keypad, keyboard, touch screen, or other device that may accept user information, and an output device that conveys information associated with the operation of the computer (1102), including digital data, visual, or audio information (or a combination of information), or a GUI.

The computer (1102) may serve in a role as a client, network component, a server, a database or other persistency, or any other component (or a combination of roles) of a computer system for performing the subject matter described in the instant disclosure. In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) may receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) may communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that may be connected to the network (1130). The memory may be a non-transitory computer readable medium. For example, memory (1106) may be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) may be external to the computer (1102).

The application (1107) is an algorithmic software engine providing functionality according to particular needs, desires, or particular implementations of the computer (1102), particularly with respect to functionality described in this disclosure. For example, application (1107) may serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) may be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A multimode Coriolis flow meter comprising:
a vibratable conduit configured to channel a flow of a multiphase fluid;
a plurality of drivers connected to the vibratable conduit configured to induce a plurality of vibration modes to the vibratable conduit;
a plurality of sensors connected to the vibratable conduit and configured to generate a plurality of sensor signals of the vibratable conduit in response to the plurality of vibration modes; and
a Coriolis transmitter configured to:
transmit a plurality of drive signals to the plurality of drivers to maintain a continuous motion of the vibratable conduit in the plurality of vibration modes;
receive the plurality of sensor signals from the plurality of sensors;
determine, via a Prism signal processing, a plurality of frequencies, a plurality of amplitudes, and a plurality of phase differences for each of the plurality of vibration modes based on the sensor signals;
generate an apparent mixture mass flow rate measurement for each of the plurality of vibration modes corresponding to the continuous motion of the vibratable conduit based, at least in part, on the plurality of phase differences; and
generate an apparent mixture density measurement for each of the plurality of vibration modes corresponding to the continuous motion of the vibratable conduit based, at least in part, on the plurality of frequencies.

2. The multimode Coriolis flow meter of claim 1, wherein the plurality of vibration modes further comprises a natural resonant frequency of mechanical vibration for the vibratable conduit.

3. The multimode Coriolis flow meter of claim 1, wherein the plurality of vibration modes comprises a Drive mode and a Coriolis mode.

4. The multimode Coriolis flow meter of claim 1, wherein the plurality of drivers is configured to induce vibration of the vibratable conduit in one or more vibration modes simultaneously.

5. The multimode Coriolis flow meter of claim 1, wherein an error characteristic for the apparent mixture mass flow rate measurement and an error characteristic for the apparent mixture density measurement are different for each vibration mode.

6. The multimode Coriolis flow meter of claim 1, wherein the Prism signal processing is configured to perform bandpass, low-pass, and notch filtering operations on the plurality of sensor signals.

7. The multimode Coriolis flow meter of claim 1, wherein the plurality of frequencies for each of the vibration modes may be determined by the Prism signal processing even if the plurality of frequencies are in close proximity to one another.

8. A non-transitory computer readable medium storing instructions executable by a computer processor, the instructions comprising functionality for:
obtaining data from a plurality of sources, the data including temperature, pressure, apparent mixture mass flow rate for each of a plurality of vibration modes, and apparent mixture density for each of a plurality of vibration modes;
processing the obtained data, wherein the processing includes cleaning and normalizing the obtained data;
determining, using a correction model, a mixture mass flow rate error and a mixture density error based on, at least, the processed data;
determining, using the correction model, a corrected mixture mass flow rate and a corrected mixture density based on, at least, the mixture mass flow rate error and the mixture density error; and
determining, using the correction model, corrected mass flow rates of individual multiphase flow components in real-time based on, at least, the corrected mixture mass flow rate and the corrected mixture density.

9. The non-transitory computer readable medium of claim 8,
wherein the correction model is a machine learning model, and
wherein the machine learning model includes a gradient boosting algorithm, a neural network, subsampling, and a regularization term.

10. The non-transitory computer readable medium of claim 9, further comprising:
selecting, using the computer processor, a machine learning model type and a plurality of hyperparameters;
evaluating, using the computer processor and a loss function, the selected machine learning model based on its predictive performance on a desired target output;
adjusting, using the computer processor and the loss function, the plurality of hyperparameters; and
re-training, using the computer processor, the selected machine learning model with the adjusted plurality of hyperparameters.

11. The non-transitory computer readable medium of claim 8, wherein determining the mixture mass flow rate error and the mixture density error using a neural network comprises:
generating, using the computer processor, relationships between the data and a target initial mixture mass flow rate error and mixture density error by adjusting weights and biases of neurons in the neural network; and
determining, using the computer processor, an initial mixture mass flow rate error and mixture density error based on the generated relationships.

12. The non-transitory computer readable medium of claim 8, wherein the plurality of vibration modes further comprises a natural resonant frequency of mechanical vibration for a vibratable conduit.

13. The non-transitory computer readable medium of claim 8, wherein the plurality of vibration modes comprises a Drive mode and a Coriolis mode.

14. The non-transitory computer readable medium of claim 8, wherein an error characteristic for the apparent mixture mass flow rate and an error characteristic for the apparent mixture density are different for each of the plurality of vibration modes.

15. A system comprising:
a vibratable conduit configured to channel a flow of a multiphase fluid;
a plurality of drivers connected to the vibratable conduit configured to induce a plurality of vibration modes to the vibratable conduit;
a plurality of sensors connected to the vibratable conduit and configured to generate a plurality of sensor signals of the vibratable conduit in response to the plurality of vibration modes;
a Coriolis transmitter; and
a multiphase flow error correction system comprising a computer processor, wherein the multiphase flow error correction system is coupled to the Coriolis transmitter, the multiphase flow error correction system comprising functionality for:
obtaining data from a plurality of sources, the data including temperature, pressure, apparent mixture mass flow rate for each of the plurality of vibration modes, and apparent mixture density for each of the plurality of vibration modes;
processing the obtained data, wherein the processing includes cleaning and normalizing the obtained data;
determining, using a correction model, a mixture mass flow rate error and a mixture density error based on, at least, the processed data;
determining, using the correction model, a corrected mixture mass flow rate and a corrected mixture density based on, at least, the mixture mass flow rate error and the mixture density error; and
determining, using the correction model, corrected mass flow rates of individual multiphase flow components in real-time based on, at least, the corrected mixture mass flow rate and the corrected mixture density.

16. The system of claim 15, wherein the plurality of vibration modes further comprises a natural resonant frequency of mechanical vibration for the vibratable conduit.

17. The system of claim 15, wherein the plurality of vibration modes comprises a Drive mode and a Coriolis mode.

18. The system of claim 15, wherein the plurality of drivers is configured to induce vibration of the vibratable conduit in one or more vibration modes simultaneously.

19. The system of claim 15, wherein an error characteristic for the apparent mixture mass flow rate and an error characteristic for the apparent mixture density are different for each of the plurality of vibration modes.

20. The system of claim 15, wherein a Prism signal processing is configured to perform bandpass, low-pass, and notch filtering operations on the plurality of sensor signals.
